(19) United States
(12) Patent Application Publication
(10) Pub. No.: US 2009/0228962 A1
(43) Pub. Date: Sep. 10, 2009

(54) ACCESS CONTROL AND ACCESS TRACKING FOR REMOTE FRONT PANEL

(75) Inventor: Rabindra Pathak, Vancouver, WA (US)

Correspondence Address: Stolowitz Ford Cowger LLP/Sharp, 621 SW Morrison St, Suite 600, Portland, OR, 97205, US

(73) Assignee: SHARP LABORATORIES OF AMERICA, INC., Camas, WA (US)

(21) Appl. No.: 12/043,930

(22) Filed: Mar. 6, 2008

(51) Int. Cl. G06F 21/00

(52) U.S. Cl. 726/5

(57) ABSTRACT

The present disclosure pertains to improvements in remote network device management, for example remote front panel applications for managing imaging devices and multi-function peripherals (MFP's) in a network. A centralized MFP device management application software tool provides improvement in security and convenience, including a auto-login feature based on stored user credentials. Another aspect of the present disclosure provides for tracking remote device access activity. Still a further aspect of the present disclosure addresses the problem of resolving simultaneous access to the same device either remotely or through a combination of remote and local access. Yet a further aspect of this disclosure relates to enabling concurrent remote access to multiple devices using a single login procedure.

### RELATED APPLICATIONS

None.

### TECHNICAL FIELD

This invention pertains to methods, apparatus and software for improved security and other benefits in the remote management of imaging devices, multi-function peripherals (“MFP”) and the like over a network.

### BACKGROUND OF THE INVENTION

Remote management of MFP's and other imaging devices is advantageous for several reasons. It is time consuming and often impractical for managers to have to physically get in front of each MFP to interact with the front panel interface. While remote management of devices offers great benefits like flexibility, convenience and efficiency, it also exposes the devices to security risks. “Remote front panel” is an important feature of remote management capability. Historically, user had to walk up to the MFP and manually operate the front panel on the device to accomplish many configuration and troubleshooting activities. Now these tasks can be performed remotely, but the tools lack adequate security mechanisms to prevent unauthorized access to remote front panel applications. Additional problems and limitations of the prior art are discussed below.

### SUMMARY OF THE INVENTION

The present disclosure, in various embodiments and implementations, pertains to improvements in remote device management, including but not limited to improvements in security, to prevent unauthorized remote management activity. Another aspect of the present disclosure provides for tracking remote device access activity. Still a further aspect of the present disclosure addresses the problem of resolving simultaneous access to the same device either remotely or through a combination of remote and local access. Yet a further aspect of this disclosure relates to enabling concurrent remote access to multiple devices using a single login procedure.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a simplified diagram of an illustrative digital network.

FIG. 2 is a simplified flow diagram of one embodiment of a method for remote front panel access.

FIG. 3 is a block diagram of software modules in one embodiment of a device management software application that supports remote front panel access.

FIG. 4 is a simplified diagram representative of one embodiment of a user interface screen display showing a device view page with remote front panel access.

### DETAILED DESCRIPTION OF PREFERRED EMBODIMENTS

In this application, we will simply use the term “MFP” to mean any imaging device, including but not limited to multi-function peripheral devices, that is capable of remote management. While MFP's often are connected to a network, e.g., via an Ethernet or wireless interface, we also include in our definition devices that may be directly connected to a user's computer or server, sometimes called attached or local peripherals. In such cases, attached devices are accessible through a network to which the host computer is coupled, and thereby can be accessed remotely.

We use the term “remote management” herein to refer to management of an MFP through a software interface running on a device (typically a computer) other than the MFP itself. The term “remote” in other words means interacting with the MFP though an electronic interface other than manually operating a front panel on the machine. “Management” of a peripheral for present purposes refers broadly to any interaction (unidirectional or bidirectional) with the peripheral for a purpose other than simply sending a user job for processing, such as a print or fax job. Management of an MFP can include without limitation changing configuration settings, collecting current status or operating statistics, and troubleshooting various potential MFP problems.

Limited technologies exist for remote control of certain devices. In general, known remote management solutions require a user login, and password or similar validation, each time a user remotely accesses a given device. To access a second device, the user must “start over” and has to separately log into the second device, often using a different user name, password or other credentials to access the second device. Examples of such solutions are disclosed, for example, in JP 2005-011090, JP 2006-246408 and others. Additional prior art references can be found in the record of the present application.

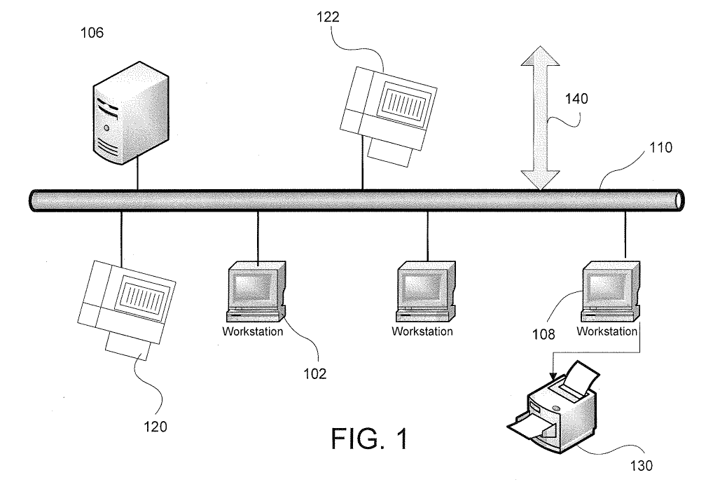

FIG. 1 is a diagram of an illustrative digital network or LAN. This is highly simplified for illustrative purposes only; a wide variety of network capabilities and topologies are well known. This diagram illustrates a network communication medium 110, which may be, for example, an Ethernet connection. Other physical media and various known protocols may be used to apply one or more of the inventive principle disclosed herein in various network implementations. These principles further can be adapted to follow technical advances in digital networks, peripheral devices, and communications methods and equipment, allowing network and IT managers to utilize best tools as they evolve over time in the marketplace. Some parts of the illustrative network 100 may be wireless in some embodiments. In some embodiments, the network may have a gateway, bridge or other interface component 140 for external communications or to couple it to a larger network.

In the network 100, there are computers 102, 104 or other computing devices, interconnected via the medium 110. The number of such devices is immaterial here. The network 100 may also include one or more servers 106. Computer 108 may be a user (client) machine with an attached printer 130. In another implementation, computer 108 may serve as a network printer server/spooler for utilization of the printer 130. The network 100 also includes at least one MFP 120, 122 which can be remotely accessed as explained below.

In some implementations, the MFP 122 may be managed from a client device, for example 102, while in other systems the MFP may be managed from a remote location via the local network interface 140, for example in the case of a WAN. In some embodiments, a user/manager can access multiple different MFP's from any location on the network, using a single login, as further explained below.

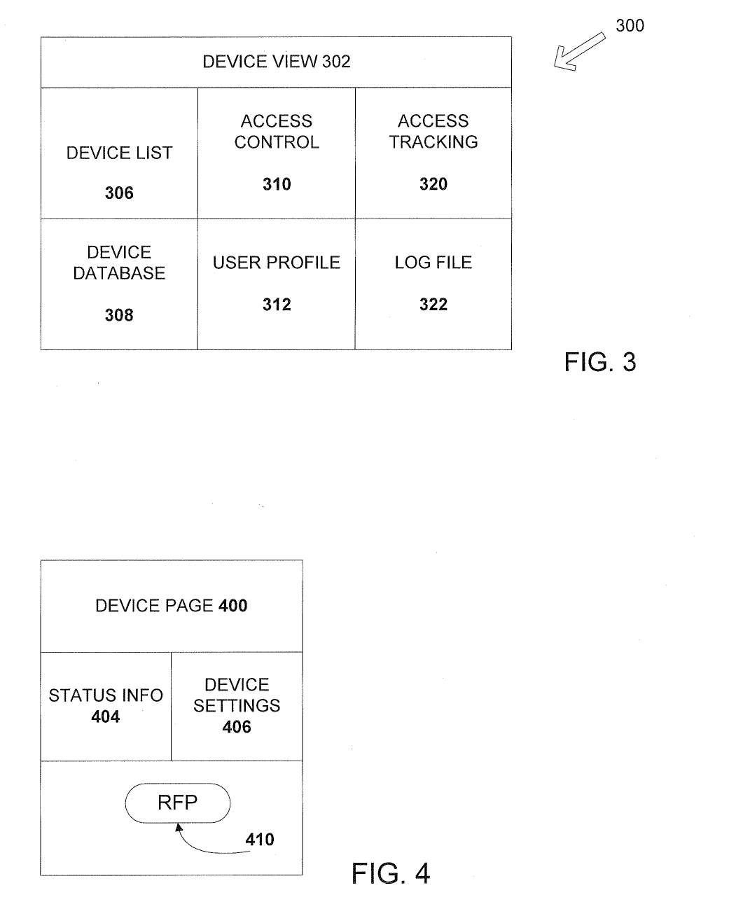

FIG. 3 is an illustrative block diagram of software modules in one embodiment of a device management software application 300 that supports remote front panel access consistent with the present disclosure. In the illustrated embodiment, the “device view” module 302 (the name is not critical) provides display of a “device page” screen to the user. The device page screen display preferably includes information about the corresponding device including, for example, its current status and configuration settings. FIG. 4 shows a simplified example of a layout of a “device view” screen display 400. The layout 400 includes a status region 404 to display status details and a device settings or configuration region 406 to display those parameters. Specific display elements of the regions 404, 406 will vary by device and implementation and are not critical.

The device view display 400 also includes an “RFP” or remote front panel action button 410. When the user clicks this button 410, the graphical remote front panel display for the current device is displayed and becomes active. Preferably, the device view module will launch the remote front panel as a new process which runs in a separate browser or window. Details of such a display are known, and may employ, for example, HTML technologies for interacting with the remote MFP. However, before RFP is enabled, the capability is subject to access control as follows.

Referring again to FIG. 3, the device view module 302 in operation fetches a list of devices 306 managed by the device management software. This device list preferably is stored in a database and managed by a device database module 308. The device view module 302 communicates with an access control module 310 to verify whether the current user is logged into the management system with required privileges. If the user is not logged in with the necessary privileges, the RFP capability will be prevented. In one embodiment, where RFP is not allowed for the current user, the device view display of FIG. 4 will omit (or “gray out”) the RFP action button 410. Conversely, if the current user is logged in with necessary privileges, the RFP button will enable remote front panel interaction as mentioned above.

In FIG. 3, the access control module 310 in one embodiment interacts with a User Profile Database 312 to fetch user profile information. Preferably, this data includes some information about the user, such as name, address, contact information and device management credentials. These credentials preferably may include a user name, password, and in some embodiments digital certificates. Typically, a digital certificate is a secure digital identity that certifies the identity of the holder. Issued by a Certification Authority, it may contain a user's name, public key, and related information. A digital certificate is tamper-proof and cannot be forged, and is signed by the private key of the Certification Authority which issued it. However, within a specific enterprise or company, the company itself (or its IT department) may act as a local certification authority to issue certificates for internal use. Other mechanisms can be used as well to verify user credentials such as LDAP, Windows® NTLM and other Enterprise Directory Service Applications.

Preferably, the user need only log into the device management application 300 once in order to gain access to all remote devices the user is authorized to access in accordance with that user's credentials. The access control module 310 also manages the MFP or device credentials. An MFP credential as used herein is the information needed for a user to login to a corresponding MFP device. Typically, each MFP (120, 122 in FIG. 1) will require individual authentication including a corresponding user name and password in order to grant access to service features like remote front panel. (Login may or may not be required at the physical front panel.)

The access control module 310 implements a mechanism by which service level users can provide the necessary MFP credentials, just one time (until an update is needed). The access control module stores the MFP credentials in the user profile database 312. Once the user is logged in to the management application, the user can switch MFP's or access additional MFP devices as needed, without additional login procedures or credentials. Instead, the access control module will fetch the username and password information appropriate to each device the user seeks to access. The access control module preferably interacts with each remote device, performing the required login procedure in each instance for the user automatically. These credentials can be stored in the user profile database 312. The database is maintained and update as appropriate by the access control module. In this way, the user need not remember or provide login information separately for each MFP device.

There may be, in some embodiments, multiple levels or classes of users or user privileges. In one example, a “general user” in one scheme is permitted to access only a limited amount of information about an MFP device, and they may not have permission to perform any action on that device. For example, they might view a job queue or toner level, but lack authority to change configurations or cancel a job. In fact, to access generic information, login may not be required at all. In another case, “service level” users will have access to more detailed information about the device, and will have permission to perform certain actions on the device such as upgrading the firmware, changing device settings or rebooting the device.

These features can be implemented using the software described above. Separate login for particular features or services on a device need not be required of the user. Rather, automatic login will be conducted on behalf of the user by the management application as needed. Once the user has logged into the management system, that user's privileges for each device (in the device list 306) are known the access control module. That module, in turn, may interact with the device view module to modify the device view display in accordance with the user's credentials for each device. In the example above, the user is granted (or denied) front panel access entirely, and this is reflected in the device view by displaying (or not) the front panel access action button. In another example, even though the user has front panel access, only certain actions may be permitted by her credentials. In some embodiments, those limitations may be reflected by modifying the front panel display presented to the user. Specific variations in the user interface display can be arranged by those skilled in the art in view of the present disclosure.

### Access Control Resolution

When a user directly accesses the physical front panel of an MFP device, and a second user or application remotely accesses the same device, a conflict can arise. Similarly, remote access my multiple users can result in conflicts. In one embodiment, the present software can prevent multiple simultaneous accesses to the front panel (physical or virtual) of a particular MFP. In order to avoid multiple concurrent accesses to the front panel of the same MFP device, in some embodiments, the access control module ensures that only one window or browser is open for a given MFP at one time. This is one additional benefit of the centralized management system disclosed herein. If a remote front panel is already open in a current window or browser (or other textual, graphic or equivalent UI), a request by a user for front panel access to the same device (e.g. clicking the RFP button) will be denied. In some implementations, concurrent use prevention is conveniently supported by interaction with user access tracking and logging, described below.

The access control module preferably also ensures that if a front panel is being accessed locally (manually), then it denies remote access to the same device until the local front panel is closed. When the user clicks on the RFP button, the access control model in one embodiment first checks via the network to determine whether the corresponding physical front panel is then being accessed locally. Only if the physical front panel is not being accessed locally, the device view module will launch the separate process to run RFP for that device. Otherwise, it may display a message to the user that the front panel is not currently available for remote access.

### Multiple Simultaneous Access

Most device management applications display the remote front panel as part of the parent user interface (“UI”) screen. For example, they display the remote front panel as a frame within a browser or as a UI control within the Windows® UI. This restricts the user to accessing only one device remote front panel at a time. In accordance with some embodiments of the present invention, as mentioned above, when the user activates a remote front panel button, the device view module preferably launches the RFP as a new process in a separate browser. This embodiment enables the user to launch as many simultaneous front panel interfaces as needed. Thus the user can manage multiple MFP devices simultaneously.

### Access Tracking and Logging

Remote front panel is a powerful feature by which a user gains access to various features of a device from a remote location. For example, RFP can be used to change or update firmware, change settings, reboot the device, and even disable the device completely. With these capabilities come serious security risks, as mentioned earlier. The access control software and methods described above help to address those risks. It would also be helpful to track which users are remotely accessing which devices, and in some embodiments logging what specific actions those users are taking. Toward that end, we refer once again to FIG. 3, in which the device view module 302 may further include an access tracking module 320. The module maintains a log file 322. Whenever a user accesses a remote front panel, the device view module 302 calls the access tracking module 320 which in turn calls a log file module 322. The log file module updates a log file (not shown) with the new access information for the corresponding device. The log file can be reviewed if necessary, for example to determine who last accessed a device that has since failed. More or less detail can be maintained in the log file as selected by the enterprise or system management.

In one embodiment, the log file module 322 maintains two log files, namely backup and running log files. The size of these files preferably is configurable by user. Log file module uses the running log file to log access information as described on an ongoing basis. Whenever this file size exceeds the predetermined limit, the log file module copies the contents of the log file into the backup log file. After backup, the running log contents may be deleted or over-written going forward to make space for new data. Many different variations and details for data storage are known and are omitted here so as to avoid obscuring the present inventive disclosure.

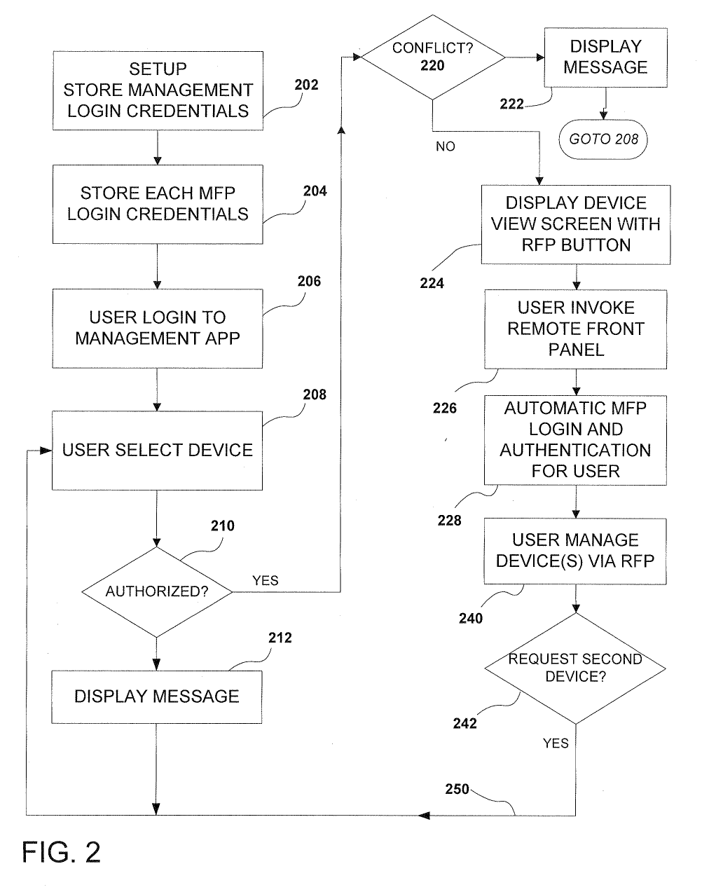

FIG. 2 is a simplified flow diagram illustrating one embodiment of a process consistent with the present disclosure. In FIG. 2, a manager or authorized user installs and configures a device management software application at step 202, including setup of user login credentials. As noted earlier, user information preferably may be stored in a local database. In addition, user credentials for each authorized MFP are stored, step 204. After setup, the application is ready for use, although user profile information can be updated as needed.

A user logs into the management application, step 206, and then selects a device or MFP in step 208. In some embodiments, a list of candidate devices may be displayed to the user. The system checks the user profile credentials for authorization to remotely access the selected device, step 210. If the user is not so authorized, the system may display a message to that effect, step 212, and then loop back to invite another selection at 208. If the user is authorized to access the selected device, the system checks for a conflict at 220, such as a prior user already logged into that same device. This conflict check may be done in various ways. In one example, a device list database is updated to maintain current information including front panel login status. The device list status may be updated on a scheduled or interrupt basis. In an alternative embodiment, the management application may query the selected device in real time to check the current front panel login status. If there is a conflict, a message may be displayed at 222, and again control loops back to 208 to invite a different selection.

If there is no conflict at step 220, the application displays a device view screen for the selected device, step 224. If remote front panel access is permitted, an RFP action button or equivalent user input means may be included in the screen display. The user may then invoke a remote front panel process, step 226, for remote management operations. At that point, the management application looks up the user login credentials for the selected device and conducts automatic login, step 228. The user can then access the front panel to manage the selected device, step 240. The user may request access to a second device, step 242. If so, the application loops via path 250 back to step 208 to enable selection of a second device. The prior RFP may remain open with access to the first device. The process outlined above continues with regard to the second selected device. assuming no conflict, proper credentials, etc., a second RFP window can be opened, and indeed additional windows can be opened so as to enable concurrent remote access to multiple remote devices. The number of such devices is not limited.

It will be obvious to those having skill in the art that many changes may be made to the details of the above-described embodiments without departing from the underlying principles of the invention. The scope of the present invention should, therefore, be determined only by the following claims.

1. A method for remote management of network imaging devices comprising:
storing indicia of user credentials in a local database accessible to the remote management tool;
checking the local database of stored indicia of user credentials to authenticate a user seeking to access remote device management;
if the user is authenticated, authorizing the authenticated user to access a remote front panel of a selected network imaging device; and
automatically logging the authenticated user into the selected device using the user credentials stored in the local database, so as to establish remote front panel access to the device for the authenticated user.

2. A method according to claim 1 and further comprising:
after authenticating the user, displaying a list of network imaging devices that the user is authorized to manage remotely, based on the user credentials stored in the local database;
receiving from the user an input selection of one of the network imaging devices for remote management;
and wherein said automatically logging the authenticated user into the selected device using the user credentials stored in the local database, so as to establish remote front panel access to the selected device for the authenticated user.

3. A method according to claim 2 and further comprising:
receiving from the user an input selection of a second one of the network imaging devices for remote management; and
automatically logging the authenticated user into the second selected device using the user credentials stored in the local database, if the user profile indicates permission to access the second selected device, so as to establish remote front panel access to the second selected device, without the user logging out of the first selected device.

4. A method according to claim 3 and further comprising:
displaying a first graphical remote front panel display in a first display window for managing the first selected device; and simultaneously
displaying a second graphical remote front panel display in a second display window for simultaneously managing the second selected device.

5. A method according to claim 3 including:
limiting the user's management privileges with respect to each of the first and second selected devices, based on the corresponding privileges stored in the local database.

6. A method according to claim 3 displaying a device view screen display to the user including status of the selected device, and including a remote front panel activation button in the screen display only if the user has permission for remote front panel access to the selected device based on the stored user credentials.

7. A method according to claim 3 and further comprising:
before said logging the user into the selected device, checking whether another user is already logged into the selected device; and
if another user is already logged into the selected device for remote management, denying remote access to the selected device to prevent multiple simultaneous management accesses to the selected device.

8. A method according to claim 7 and further comprising:
notifying the user that another user is already logged into the selected device for remote management.

9. A method according to claim 3 and further comprising:
storing a record of the user's access to manage the selected device in an access log.

10. A method according to claim 3 and further comprising:
storing the access log in the said local database.

11. A remote MFP device management application software tool comprising an executable set of instructions stored in machine-readable media, the application including:
a device database module for maintaining a list of remotely-manageable devices deployed on a network;
a user profile database module for maintaining user profile data, the stored user profile data including, for at least one user, identification of (a) at least one MFP device to which the user is permitted remote management access, and (b), for each such device, user login credentials for automatically logging the user into the corresponding MFP device to gain remote management access; and
an auto-login module for logging the user automatically into a device selected by the user from the list of devices only if the user profile data allows remote access to the selected device.

12. A device management software tool according to claim 11 including:
a device view module for displaying a device page screen to a user for a device selected from the list of network devices maintained by the software tool; wherein
the device page screen display includes selected data of the selected network device.

13. A device management software tool according to claim 12 wherein the data of the selected device displayed on the device page screen includes at least one of a device description, a firmware release identifier, a current status and a current configuration setting.

14. A device management software tool according to claim 12 including code for launching a remote front panel application as a separate process for each network device to which the user is permitted remote management access.

15. A device management software tool according to claim 12 including:
an access control module to check user login credentials against the stored user profile data to determine whether or not the user is logged into the device management software tool with sufficient privileges to allow the user to activate the said remote front panel application to manage the selected device; and wherein
if the user is logged in with sufficient privileges to allow the user to activate the said remote front panel application to manage the selected device, then the device page screen further displays a user input to activate the remote front panel application for the selected imaging device.

16. A device management software tool according to claim 15 wherein:
if the user is not logged in with sufficient privileges to allow the user to activate the said remote front panel application to manage the selected device, then the device page screen further displays a remote front panel action button that is obscured or grayed to indicate that such action is not available to the user.

17. A device management software tool comprising an executable set of instructions stored in machine-readable media for use on a machine coupled to a network in which at least one remotely-manageable imaging device can be coupled for communications, the software tool comprising:
code for storing user profile data in a local database; the user profile data including at least one set of MFP credentials for each user, and further wherein each set of user permissions is associated with a corresponding network device or predetermined group of the network devices;
an access control module to check user login credentials against the stored user profile data to determine whether or not the user is logged into the device management software tool with sufficient privileges to allow the user to activate a remote front panel application to manage a selected network device; and
an interface for communicating with the remote front panel application that implements remote management of a network imaging device;
wherein the software tool enables the user to access the remote front panel application only if the user is logged into the tool with sufficient permissions to do so.

18. A device management software tool according to claim 17 including access control resolution code to detect a preexisting user login to the remote front panel application and to prevent multiple simultaneous accesses to the front panel of the same device.

19. A device management software tool according to claim 18 and further including an access tracking module.

20. A device management software tool according to claim 18 and further including a logging module for maintaining a log file of accesses to network devices through the device management software tool.

21. A device management software tool according to claim 18 and further including a logging module for maintaining a log file of physical front panel accesses to network devices wherein the physical front panel accesses are communicated from each network device to the device management software tool for centralized logging.
